(19) United States
(12) Patent Application Publication
(10) Pub. No.: US 2020/0027574 A1
(43) Pub. Date: Jan. 23, 2020

(54) METHOD AND APPARATUS FOR CONTROLLED THERMONUCLEAR FUSION POWER

(71) Applicant: JERRY I. JACOBSON, JUPITER, FL (US)

(72) Inventor: JERRY I. JACOBSON, JUPITER, FL (US)

(21) Appl. No.: 16/512,745

(22) Filed: Jul. 16, 2019

Related U.S. Application Data
(63) Continuation-in-part of application No. 15/806,687, filed on Nov. 8, 2017.
Application No. 15/806,687 is a continuation-in-part of application No. 15/470,181, filed on Mar. 27, 2017, now abandoned.

(51) Int. Cl. G21B 3/00

(52) U.S. Cl. CPC G21B 3/008

(57) ABSTRACT

Ocean water and/or heavy water will be utilized as fuel to derive fusion energy. Utilizing multiple coiled, triple-axis systems, shall produce magnetic flux densities from 10⁻⁶ Gauss to 10⁻²¹ Gauss as derived from mc²=BvLq (Jacobson Resonance). Matter may be cajoled, such as deuterons and protons to fuse, thereby providing energy. This energy will be withdrawn for conversion of heat energy to electricity.

### RELATED APPLICATION

The present application is a continuation-in-part application of application Ser. No. 15/806,687, filed Nov. 8, 2017, entitled “Method and Apparatus for Controlled Thermonuclear Fusion Power,” which was a continuation-in-part application of application Ser. No. 15/470,181, filed on Mar. 27, 2017, entitled “Method and Apparatus for Controlled Thermonuclear Fusion Power Utilizing Extremely Low-Level Amplitude Modulated Magnetic Resonance to Overcome the Quantum Barrier by Manipulation of Dark Energy,” which are all hereby expressly incorporated by reference in their entireties.

### TECHNICAL FIELD

The present disclosure relates generally to an apparatus and method for generating electrical power; in particular, this disclosure relates to power generation through controlled thermonuclear fusion.

### BACKGROUND AND SUMMARY

Many groups have sought to replicate conditions in the sun where enormous amounts of energy are produced from the fusion of hydrogen atoms. Here on Earth, uncontrolled fusion is seen in the hydrogen bomb. Man has attempted to provide fusion power thus far through two methods, one being a brute force method, which has not worked, because conditions cannot be replicated on Earth as they are in the sun; and secondly, man has attempted to provide fusion power from systems at room temperature. These systems have thus far failed as well.

Deuterium gas can be produced through electrolysis by splitting heavy water molecules in which the hydrogen has been replaced by deuterium. When an electric current is run through the heavy water in a fusion cell, it triggers chemical reactions at the metal rods. Lithium deuteroxide (LiOD) can be added to the water to increase its ability to conduct electricity and speed up the process. At the palladium rod, the heavy water (D₂O) reacts with the electrons that make up the current to produce deuterium gas and deuterium oxide ions:

2D₂O(1)+2e⁻>D₂(g)+2OD⁻(aq)

At the platinum rod, the deuterium oxide ions react with each other to produce oxygen gas, water, and electrons:

4OD⁻(aq)>O₂(g)+2D₂O(1)+4e⁻

So in the net reaction, water decomposes into oxygen and deuterium gasses:

2D₂O(1)>O₂(g)+2D₂(g)

U.S. Pat. No. 5,198,181 for a “Stabilizing Plasma in Thermonuclear Fusion Reactions Using Resonant Low Level Electromagnetic Fields” issued Mar. 30, 1993, which is hereby incorporated by reference, discusses a technique wherein Jacobson Resonance magnetic coils encapsulate a Tokamak-type fusion test reactor in order to stabilize the deuterium ions in said system such that fusion may occur. It is supposed that the strong magnetic field utilized by Tokamak will interfere significantly with the very weak magnetic fields created by the external magnetic coils preventing the fusion reaction to provide ignition.

Controlled thermonuclear fusion power has been a significant concern since the 1950's. Magnetic confinement systems such as Tokamak, utilizing very strong magnetic fields and high temperature systems have failed to provide ignition of plasma. Laser systems such as SHEBA have also failed to provide controlled thermonuclear fusion power. Muon-catalyzed fusion has not provided success. Various reports of room temperature fusion systems have denoted failure as well. Therefore, in consideration of the great need for an alternative to usage of fossil fuels is indicated most especially to provide electrical energy. The various current modalities providing energy will, in due course, be exhausted, except for such sources as solar, wind, and hydro sources which clearly will prove insufficient. Controlled thermonuclear fusion power is the logical choice for future generation of electrical energy, while using ordinary ocean water as fuel. To provide an economical basis for energy production, while producing little radioactive material, controlled fusion is no doubt the resource for future civilization.

The room temperature system provided by Pons and Fleischman did not account for ambient electromagnetic fields which may have induced a resonant response in deuterium nuclei which could have made the first experiment work fortuitously. The experiment did not yield neutron emission which was supposed to be necessary in terms of validating the system.

However, in embodiments of the present disclosure, the resonant response is controlled with the usage of formalized calculations enabling a successful production of ignition of the plasma contained within the interstices of the palladium electrode. In embodiments of the present disclosure, so-called fusion works, at least in part, because previous attempts did not consider the importance of environmental electromagnetic fields. Indeed, in order to provide fusion for man-kind, it is important to re-create the conditions under which a star is born, rather than conditions that cannot be replicated on Earth.

In some embodiments, the system and method utilizes a new equation that unifies gravity and electromagnetism based on the equation of Jacobson Resonance; thus, we may calculate the magnetic fields necessary to tune into hydrogen ions and coax them into fusing. These calculated magnetic fields correspond to measurements of outer space magnetic fields made by NASA in the range of about a trillionth of a gauss. The Earth's natural magnetic field is about a half of a gauss. What this means is that we can communicate with individual hydrogen atoms by using a very weak force because the atoms are so small. Strong forces simply push around large aggregations of atoms and cannot create the tunneling effect between the hydrogen atoms to overcome electrostatic repulsion. When we regulate the coherent and congruent vibrational states of the atoms and make them move together (relative translational motion) then we can overcome the oppositional forces of dark matter that create the quantum barrier. When the ions are close enough together, a strong nuclear force can take over at short distances to enable protons and/or deuterons to stick together when these ions, protons, and/or deuterons fuse, energy is liberated at levels greater than 20 times the energy put into the system. Reactions like these, (from four hydrogen atoms) about 190,000 kilowatt hours, enough electrical energy to run a thousand-watt electrical appliance day and night for 20 years.

The amount of energy that can be drawn from ordinary ocean water can assure the energy source for future civilizations, for electricity, space travel, as well as cars. The simple solution is to use a system of resonance, the most general form of resonance, and is related to both magnetic resonance as well as cyclotron resonance. The value of this method and apparatus is currently inestimable, most especially because we are depleting the Earth of our fossil fuels. We have enough ocean water to last many millions of years. Essentially, by introducing the correct ambient magnetic field, based upon calculations, we can make a piece of metal sitting in ordinary ocean water, hot enough to produce 20 times more energy out than is put into the system.

Additional features and advantages of the disclosure will become apparent to those skilled in the art upon consideration of the following detailed description of the illustrated embodiment exemplifying the best mode of carrying out the disclosure as presently perceived. It is intended that all such additional features and advantages be included within this description and be within the scope of the disclosure.

### BRIEF DESCRIPTION OF THE DRAWINGS

The present disclosure will be described hereafter with reference to the attached drawings which are given as non-limiting examples only, in which:

FIG. 1 represents combination of solenoidal and poloidal coils creating three axes of Lorentz forces providing resonant magnetic flux densities for charged species contained by a vessel placed in the midst of the solenoid according to an embodiment of the disclosure.

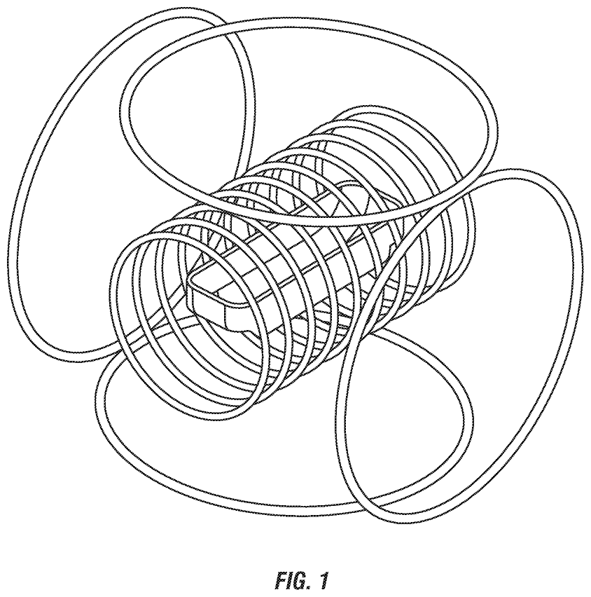

FIG. 2 represents a combination of solenoid and poloidal coils creating a double axis Lorentz form combination to induce fusions within the vessel containing ocean water according to an embodiment of the disclosure. An option for poloidal coils is to position them in a Helmholtz configuration.

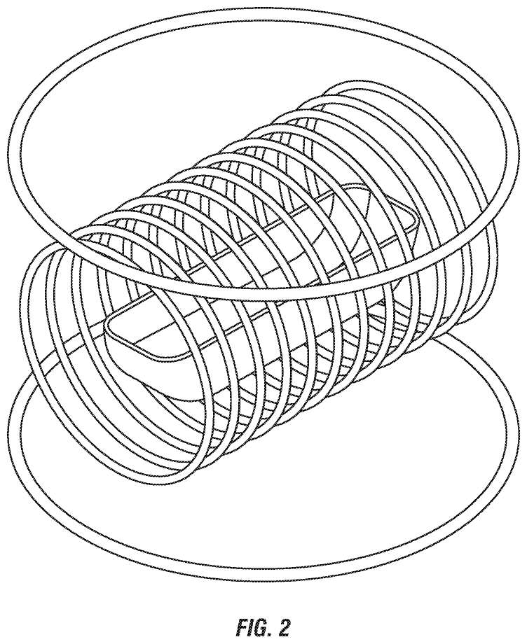

FIG. 3 represents a 6 coil system creating a triple axis orientation of Helmholtz design wherein the magnetic flux density may be homogeneous and isotropic, and electromagnetic fields are balanced and aligned according to time and magnitude according to an embodiment of the disclosure.

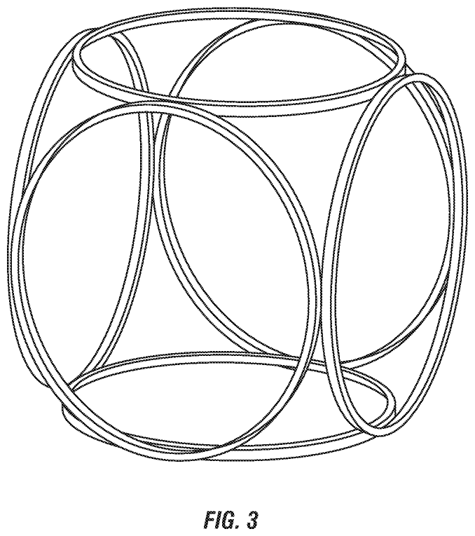

FIG. 4 represents a triple axis system wherein four coils are rectilinear and the central coil is solenoidal to therein contain the insulating vessel holding ocean water in its midst according to an embodiment of the disclosure.

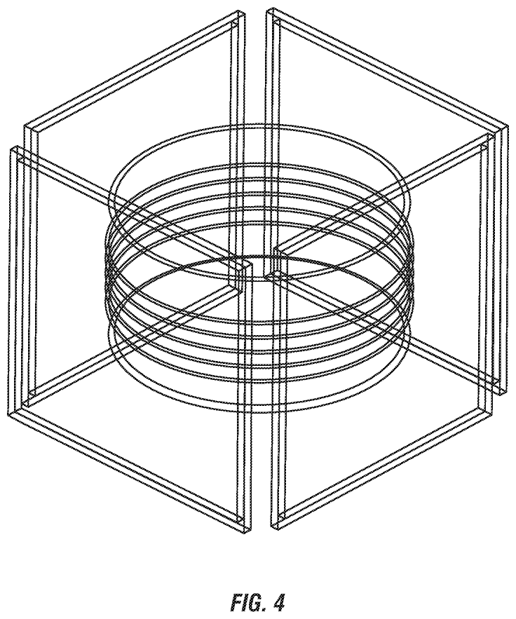

FIG. 5 represents the usage of plates in lieu of coils in addition to a solenoidal system in the center creating once again, a triple axis vector field for fusion according to an embodiment of the disclosure.

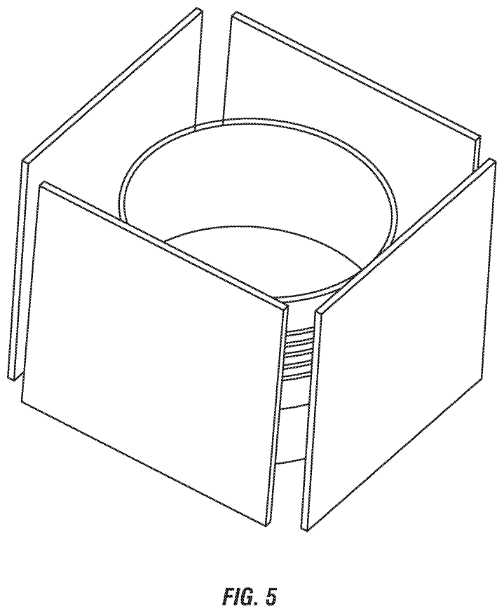

FIG. 6 represents usage of multiple and varying size coils to concentrate magnetic field lines in a particular direction; whereas this approach may be utilized in a single axis, double axis, or triple axis system according to an embodiment of the disclosure.

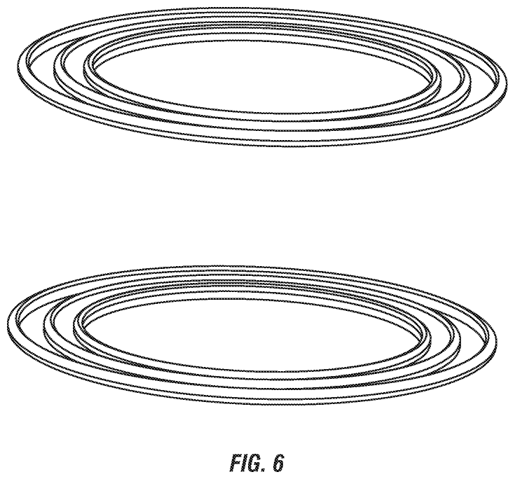

FIGS. 7-9 represents directional rotation of particulate masses according to an embodiment of the disclosure.

FIG. 10 is a schematic representation of an example fusion apparatus according to an embodiment of the disclosure.

The drawings provide examples of various coil and plate designs for creation of magnetic fields may include combinations of poloidal coils in conjunction with solenoidal coils. The combinations thereto may provide magnetic fields that are homogenous and isotropic in one, two, three, or more directions in order to regulate the inertial states of particulate matter for fusion power. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

Jacobson Resonance delineates mass as (m). The deuteron is an example of such a mass as may be applicative to the Jacobson Resonance calculation. Mc² provides the intrinsic energy of the ion. BvLq represents the EM interaction energy, emitted as a wave. The wave connects to the dark energy of space. Dark energy is the collection of masses vibrating in ordered patterns through ordinary matter. Although dark matter does not actually touch ordinary mass, the connection remains as a singularity. There is a conversion of EM wave via gravity wave to dark energy with communication to form a phonon (quantized vibration) in the field of ordinary matter. The velocity (v) is an inertial velocity (of constant velocity motion), such as Earth's orbital velocity, solar system velocity, local star cluster velocity . . . etc. Earth's orbital velocity is about 3×10⁶ cm per second.

The (L) is the longest dimension of the electrode and or/the vessel containing ocean water. Q is a single unit of electric charge in CGS, i.e. the ab coulomb.

$$B = \frac{m}{qT}$$

by definition as derived from the magnetic component of the Lorenz force equation. The units are now seen:

$$\frac{{mass ( distance )}^{2}}{{time}^{2}} = ( \frac{mass}{unit charge \cdot time} ) ( \frac{distance}{time} ) ( distance ) ( unit charge )$$

The magnetic field B with very low frequency, below 1 Hertz, will reorient dark energy to promulgate an electromechanical transduction. The deuterons will overcome the quantum barrier through subtle forces as opposed to brute force, as seen in the Tokamak Test Fusion Reactor or the SHEBA utilizing lasers and extremely high temperatures. Cajolement as opposed to brute force is the essential underpinning mechanism for universal design.

### Dark Energy

Dark matter contains other states of Reality as described in part by Kalusa Kline Theory. The number of dimensions is not actually known. When one equates the term “dimension” with “other states of reality” it is erroneous to equate the term dimension with the possible multitudinous other states of reality. It is more accurate to describe dark energy/dark matter in terms of a four dimensional continuum as existent in other states of reality or coordinate systems of reference. It is important to note that the negative electrode, e.g. palladium will have micropores and/or microtrebeculae which shall encapsulate lacunae. Whereas, controlled thermonuclear fusion energy shall be liberated secondary to fusion of deuterium ions, therein cajoled to fuse as a consequence of coherent vibrational states induced in dark matter, i.e. interstitial matter comprising other states of reality. Electrons are also tuned by Jacobson Resonance; indeed, all subatomic particles known may prove useful as target masses, e.g. neutrinos that are smaller than electrons perhaps by a factor of about 10⁴ to 10⁵. Target masses such as muons or tao may be utilized as mesonic targets having masses in between that of protons and electrons. The physical definitions of units are thus proposed to discover dark energy and its relation to ordinary matter.

### Hidden Interstitial Mass: Dark Energy

We shall initially set aside vector analysis, and consideration of supplementary units, i.e. plane and solid angles, while including as needed derived units with special names. We view the following line of reasoning from a base unitary perspective, keeping in mind Einstein's final concern that an attempt must be made to find a purely algebraic theory for the description of reality. [6]

From the magnetic component of Lorentz force equation, we consider

$$B = \frac{F}{qv sin φ} ( \frac{Newton}{coulomb meter / sec} ) \qquad ( 1 )$$

### In MKS, and

$$B = \frac{F}{qv sin φ} ( \frac{dyne}{ab - coulomb centi meter / sec} ) \qquad ( 2 )$$

In CGS, and

Denoting magnetic flux by,

$$B = \frac{φ}{A} ( \frac{dyne}{{meter}^{2}} ) ,$$

where in MKS units

$$1 Tesla = \frac{1 weber}{{meter}^{2}} ,$$

where in MKS units,
And in CGS units,

$$\begin{matrix}1 gauss = \frac{1 max well}{{cm}^{2}} & ( 5 ) \\ And \frac{1 weber}{{m}^{2}} = {10}^{4} gauss & ( 6 )\end{matrix}$$

1 Newton is defined as the force that provides a mass of one kilogram with an acceleration of one meter per second per second.

### Thus,

$$\begin{matrix}1 Tesla = \frac{\frac{kg \cdot m}{{sec}^{2}}}{\frac{coulomb \cdot m}{sec}} = \frac{kg \cdot m \cdot sec}{{sec}^{2} coulomb \cdot m} & ( 7 ) \\ 1 Tesla = \frac{kg}{coulomb \cdot sec} = {10}^{4} gauss & ( 8 ) \\ And , & \\ 1 gauss = \frac{gm \cdot cm \cdot sec}{{sec}^{2} \cdot ab - coulomb \cdot cm} = \frac{g}{ab - coulomb \cdot sec .} & ( 9 )\end{matrix}$$

As denoted by Eqs. (8) and (9), the flux density B represents

$$\frac{mass}{( charge \cdot time )}$$

Since charge is a property of certain elementary particles, by definition, that causes them to exert forces upon one another, and the force is thought to result from the exchange of photons between said particles; charge is a function of certain masses as observed in nature. The coulomb corresponds to a charge of 6.25×10¹⁸ electrons. Since reality reduces to matter and motion/interaction of matter, we may write:

$$\begin{matrix}1 coulomb = 6.25 \times {10}^{18} electrons . mass of e ( 9.1095 \times {10}^{- 12} kg ) \\ Thus , 1 coulomb = 5.6934375 \times {10}^{- 12} kg \\ Since 1 Tesla = 1 kg / 5.6934375 \times {10}^{- 12} kg . sec , & ( 10 ) \\ \frac{1 Tesla = 1.756408 \times {10}^{11} kg ( invisible mass )}{1 kg ( visible mass ) . sec} & ( 11 ) \\ and & \\ \frac{1 Gauss = 1.756408 \times {10}^{7} gm ( invisible mass )}{1 gm ( visible mass ) . sec} & ( 12 )\end{matrix}$$

The single conventional magnetic line of force in a vacuum carries about 17 14 million grams of unseen matter every second through a mass of ordinary matter of one gram. It is clear that a material substance fills all of space, and this is evidenced by definition of conventionally utilized physical units, and the perception that gravity exists everywhere in the universe.

It is evident that the combination or very light nuclei to form heavier ones results in an increase in binding energy per nucleon. Since it results in a more stable nucleus, it is known that such a reaction will release a large amount of energy.

The amount of energy equivalent to the difference between the combined masses of four hydrogen atoms or a (combination of deuterium atoms), and one helium atom is about 28.3 Mev or about 4.53×10⁻¹² joule. For every proton used in this reaction then, 1.13×10⁻¹² joule of energy will be released. Each gram of protons involved in this sample reaction will release about 6.8×10⁻¹² joule of energy. If this were converted into electrical energy, we would have 190,000 kilowatt-hours from the reaction of about 1 gram of protons, enough to operate a 1000 watt appliance continuously, day and night, for more than twenty years.

Let us take for example a mass of 4×10⁻²⁶ grams, the mass of a meson, let the distance be equal to r. As per Coulomb's law, electrostatic force is given by e²/r² wherein e is 4.77×10¹⁰ esu, i.e. elementary electric charge. As per Newton's law, gravitational interaction is given by

$$\frac{{GM}^{2}}{{r}^{2}}$$

where G (6.67×10⁻⁸) is the gravitational constant and M (4×10⁻²⁶ gm) is the intermediate mass. The critical elemental question is, “Why is the ratio of the two forces

$$\frac{{e}^{2}}{{GM}^{ 2}} ;$$

whereas this ratio is equal to 10⁴⁰?” This differential may be explained by recalling the definition of a gauss, wherein 1 gauss is about equal to 1.75×10⁷ grams of invisible mass, divided by a single gram of visible or ordinary mass X 1 second. If we mathematically cancel the unitary masses, a single gauss may be expressed as a frequency (f). This frequency of 1.75×10⁷ Hertz may be introduced into the formula: energy=Plank's constant X Frequency, or E=hf.

Planck's constant is about 6.626×10⁻²⁷ erg·sec when f=1.75×10⁷ Hertz, E is about 1.16×10⁻¹⁹ ergs. Utilizing e=mc², we find that 1.16×10⁻¹⁹ ergs divided by c² equals about 1.29×10⁻⁴⁰ gram. Thus accounting for the differential between ordinary mass and the substructures that comprise the gravitational field. The differential is 10⁴⁰ because ordinary mass per gram may be relatable to the essential underpinning substructure of gravity at 10⁻⁴⁰ grams. The particles that comprise the gravitational field are in general 10⁴⁰ times smaller than the particles responsible for the electric force. The differential relates unit mass regarding electromagnetic field and the ultimate unit mass of gravitational field. The substrates of dark energy are elementally small but combine to form other states of reality in such a manner so as to avoid direct touching of the ordinary four dimensional field of matter.

### The Derivation

As a joint result of the motion and the magnetic field every charge in a conductive body experiences, there is a resultant Lorentz force. Representing the magnetic component, we desire in non-vector notation,

F=qvB sin θ (1)

Where F is force, q is charge, v is velocity, and B is magnetic flux density. Eq (1) assumes that vectors v and B are perpendicular. The force acts in a direction that is perpendicular to both the direction of motion and the magnetic field; whereas θ is the angle that the direction of motion of the particle makes with the magnetic field. If a body is being accelerated, there is a resultant force acting on the body. If the acceleration (of the center of a uniform body) is given by a vector \vec{a}, and the resultant force on the body is given by a vector \vec{F}, Newton's Second Law states that,

[symbol]

= [symbol] (2)

Combining eqs. (1) and (2) maintaining unitary conformance, and setting aside vector notation, we discern,

$$F = ma = qvB = ( q ) ( \frac{L}{t} ) ( \frac{m}{qt} ) = \frac{mL}{{t}^{2}} \qquad ( 3 )$$

Where B=m/qt, t is time, and L is distance.

The electric potential energy per unit test charge is customarily called the electric potential, ϕ, or the voltage, V. (We shall now use the former term; in circuit applications, the latter is employed). Since ϕ=U/q (where U is electric potential energy), and E_{F} (electric field strength)=F/q, ϕ and E_{F} enjoy the same relation as U and F:

ϕ(x,y,z)=−∫_{∞}^{(x,y,z)}E_{F}·ds=−∫_{∞}^{(x,y,z)}E_{Fx}dx+E_{Fx}dy+E_{Fy}dz(V) (4)

E_{F}=(_{∂x}^{∂ϕ}i+_{∂y}^{∂ϕ}j+_{∂z}^{∂ϕ}k)(V/m) (5)

The unit of electric potential is the volt (V), where 1 V=1 J/C. Also, 1 V/m=1 N/C.
Generalizing, if there exists a charge q at a point, and there is an electrostatic force [symbol] acting on the charge, due to other charges around, the electric field [symbol] _{F} at the point is defined as

$${\vec{E}}_{F} = \frac{\vec{F}}{q} \qquad ( 6 )$$

For the purpose of nomenclature, we shall henceforth denote electric field strength as E_{F} and energy will be represented by E. Furthermore, electric potential V at a point in an electric field is the work required to bring unit electric charge from infinity to the point. It is measured in volts. If work of one joule is required to move a charge of one coulomb to the point, its potential is one volt.

The strength of an electric field EF is also given by

$${\vec{E}}_{F} = \frac{V}{L} \qquad ( 7 )$$

And, it is duly noted,

$$V = \frac{E}{q} \qquad ( 8 )$$

Combining Eqs. (6), (7), and (8), setting aside vector analysis, we derive

$$F = q {E}_{F} = \frac{qV}{L} = \frac{qE}{qL} = \frac{E}{L} = qvB \qquad ( 9 )$$

Concerned only with qualitative fundamental unitary measures, we desire

E=qvBL (10)

Wherein q v B L represents a resonant electromagnetic interaction energy, as we shall soon see.
We note Einstein's law, the law of the equivalence of mass and energy in generic form

E=mc² (11)

Where c is the velocity of light in vacuo. Thus, a quantity of energy E has a mass m, and a mass m has intrinsic energy E.
Then, from Eqs. (9) (10) and (11),

E=mc2=FxL=−=qvBL (12)

From Eq. (8) we note,

E=qV (13)

Now, recapitulating,

$${E}_{F} = \frac{V}{L} = \frac{E}{qL} = \frac{F \times L}{qL} = \frac{F}{q} = \frac{qvB}{q} = vB \qquad ( 14 )$$

And, from Eq. (3) we noted

$$B = \frac{m}{qt} \qquad ( 15 )$$

Therefore, from Eqs. (14) and (15)

$$\frac{mv}{qt} = vB = \frac{E}{qL} = {E}_{F} \qquad ( 16 )$$

With Eq. (10) rearranged, and from Eq. (16) we see

E=vBqL (17)

Thus from a qualitative foundational unitary perspective, we may now consider rearranging Eq (17), and we see

$$E = {mc}^{2} = BvLq = \frac{{mL}^{2}}{{t}^{2}} = ( \frac{m}{t} ) ( \frac{L}{t} ) ( L ) ( q ) \qquad ( 18 )$$

Electromotive force Vi is the algebraic sum of the potential difference acting in a circuit. It is measured by the energy liberated when unit electric charge passes completely round the circuit in the direction of the resultant emf. An agent such as a battery or generator has an electromotive force (emf) if it does work on the charge moving through it, the charge receiving electrical energy as it moves from the lower to the higher potential side.

Emf is measured by the potential difference (p.d.) between the terminals when a battery or generator is not delivering current. The units of emf are the same as the units of p.d. since both are measured by work per unit charge. If a battery sends a current I through an external resistance R joining its terminals, the emf of the battery is equal to (R+b) I, where b is the internal resistance of the battery. It is thought that while the term emf is sometimes used as equivalent to potential difference, strictly speaking it should be applied only to a source of electric energy. However, in consideration of the fact that we are concerned with unifying the forces of electricity, magnetism and gravity, we must consider that electric energy may be converted to magnetic energy, and to gravitational energy; because energy is defined as mass times distance squared over time squared. Essentially, we are denoting that all material interactions are a product of the conceptual substrates: mass, distance and time. Further to this end, we view all living systems as complex homeostatic arrays of biologically closed electric circuits. (21).

Hence, we desire:

$${V}_{i} = \frac{E}{q} \qquad ( 19 a )$$

Where Vi is induced electromotive force (emf). The emf Vᵢ induced in a straight conductor of length L moving with velocity v perpendicular to a field of magnetic induction B is

Vi=BvL (19b)

The emf Vᵢ is in volts when B is in Webers/m₂

Now, L is the length of a body; wherein all ordinary material bodies are essentially condensations of electromagnetic field, and have a longest dimension (5,7).

Whereas B, v and L are orthogonal and accepting the unitary equivalencies, we see from Eqs. (14) and (19 a,b)

$${V}_{i} = \frac{E}{q} = BvL \qquad ( 20 )$$

q
Where q is unit charge by definition.
Therefore, we may reiterate the finding in Eqs. (18) and (20) as

$$E = BvLq = m {c}^{2} = \frac{{mL}^{2}}{{t}^{2}} \qquad ( 21 )$$

Furthermore, we desire,

E=hf=mc²

Where E is energy, h is Planck's constant (defined as mc²t), f

is frequency, m is mass and c is the velocity of light.

### Note,

c=λf (23)

Where λ is wavelength, and f=c/λ

### Therefore,

$$m {c}^{2} = \frac{hc}{λ} \qquad ( 24 )$$

### Dividing by c, we get:

$$m c = \frac{h}{λ} \qquad ( 25 )$$

Where Eq. 25 is de Broglie's particle-wave equation. Generalizing, c=v, we desire,

$$mv = \frac{h}{λ} \qquad ( 26 )$$

It is of particular interest to place equations (22) to (26) into historical perspective. Einstein's theory proposed that for any electromagnetic wave of frequency f there is photonic energy, E=hf. The de Broglie hypothesis of light—matter symmetry required that all material particles have a wave associated with them. Utilizing the equations of relativity, de Broglie provided a formula relating wavelength to the mass and speed of the particle.

Since the energy of a photon is related to frequency f of an associated light-wave by, E=hf, and photons also possess momentum p, according to E=pc, he then derived,

$$E = pc = hf = \frac{h}{λ} \qquad ( 26.1 )$$

### Therefore,

$$P = \frac{h}{λ} \qquad ( 26.2 )$$

### Or

$$λ = \frac{h}{p} \qquad ( 26.3 )$$

Eq. (26.3) was derived specifically for the photon, considered a massless particle associated with a light-wave. However, de Broglie proposed that Eq. (26.3) applied to any particle, massless or not. (Actually, it is a simple matter to show that a photon is not massless, combining E=hf and E=mc² because a quantity of energy has a mass m, and a mass m has intrinsic energy E).

The momentum of a particle of mass m and speed v is p=mv. Therefore, Eq. (26.3) becomes

$$λ = \frac{h}{mv} \qquad ( 26.4 )$$

Whereas, Eq. (26.4) gives the wavelength λ of the de Broglie wave associated with a particle of a given mass and speed. He then had two equations, E=hf and

$$P = \frac{h}{λ} ,$$

that related particle properties (energy and momentum) to wave properties (frequency and wavelength). These equations applied equally to particles such as electrons, atoms . . . etc. as well as to photons. Material particles and photons equally obeyed the relativistic equation, E²=p² c²+m₀² c⁴, the distinction being that m₀=0 for photons. Yet, both photons and material particles had associated de Broglie waves.
Eq. (26.4) is relativistically correct when m represents the relativistic mass, rather than the rest mass m0.

m=m₀/\sqrt{1−}V²/c²

Where the rest mass m₀ can be used if the speed v is small compared to c.

The de Broglie wave of a photon is a light wave and travels at speed c, whereas speeds of waves associated with particles having mass depend on the speed of the particle. De Broglie maintained that his theory should be considered as a formal structure, and a fully formed unified doctrine. He made an especially interesting application of this principle with respect to electron orbits in the atom. An electron travels in a circular orbit about the nucleus. Assuming an electron is guided in its orbit by a de Broglie wave, if it catches up with itself, then interference must be the result. To avoid cancellation of the wave, it must be in phase with itself. De Broglie's conclusion was that a standing wave pattern must be established. The circumference of the orbit must then be equal to an exact number of wavelengths. It must be possible to fit exactly one, or two, or three, waves around the orbit. Fractions of waves would necessarily cause cancellation. The requirement was written mathematically as follows:

nλ=2πr(n=1,2,3 . . . ∞) (26.6)

Where n is an integer, λ is de Broglie wavelength, and 2πr is the circumference of the orbit with radius r; and we note

$$n λ = n ( \frac{h}{mv} ) = 2 π r \qquad ( 26.7 )$$

Eq. (26.7) can be rearranged as follows:

$$mvr = \frac{nh}{2 π} e ( n = 1 , 2 , 3 … ∞ ) \qquad ( 26.8 )$$

Eq. (26.8) represents Bohr's assumption of the quantization of angular momentum (mvr), which he utilized to obtain allowable orbits and energy levels of the hydrogen atom. Now, we extend our purview from atomic orbitals to the particles themselves. Instead of describing quarks, neutrinos, electrons, and other fundamental particles as points, string theory describes them as lines-very small, wriggling lines. Superstring theory yields a finite quantum theory of gravity, and it requires gravity for consistency.

In 1970, Yoshiro Nambu pointed out that the Dual Resonance Model was mathematically equivalent to interactions of bits of string. Originally, it was a simple formula describing hadron scattering. He pictured the particles as tiny strings about 10⁻¹³ cm long (the size of a proton). When two strings touched their tips together, they fused together into one, or conversely, one string could spontaneously split into two.

Regarding a collision, strings could absorb energy to ripple and rotate, with ends flashing about at the speed of light. In 1976, Scherk maintained that string models could represent fermions (including baryons and leptons) if fermions were matched with correspondent bosons; called for by supersymmetry. In gauge interactions, qualities like hypercharge or color could be carried by the tips of strings.

Calculations have shown that when interacting strings are in their lowest energy state; the transfer of quantum numbers is equivalent to the exchange of “massless” spin-1 particles (photons).

Furthermore, a single string can touch its own ends together and fuse into a loop; and the lowest energy state of a closed string would be “massless”, and have a spin of 2. A “massless” spin-2 particle may be equivalent to a quantized gravity wave, or graviton.

If this theory of quantum gravity is correct, then the scale of a fundamental string could be set by Planck energy. The Planck scale translates into a string about 10⁻³³ cm long, twenty orders of magnitude smaller than a proton; accounting for the fact that quarks, neutrinos and such small particles appear as infinitesimal points; and also having a lowest energy excited state about 10⁻¹⁹ times the mass of a proton.

From the idea of a relativistic quantum string, one may possibly derive a theory free of “anomalies” and “infinities,” a specification of the symmetry group of grand unification, supersymmetry, and a unification of the strong, weak and electromagnetic forces with quantum gravity.

The issue still at hand is for superstring theory to make contact with the real world. (22,23)

Now, we desire,

λ=2πL (27)

Where λ is wavelength (the circumference of a loop of string), and L is its radius.
From Eqs. (26) and (27) we see,

$$mv = \frac{h}{2 π L} \qquad ( 28 )$$

### Rearranging,

$$vL = \frac{h}{2 π m} \qquad ( 29 )$$

When both sides of Eq. (29) are multiplied by charge (q) and magnetic flux density (B), we derive,

$$BvLq = \frac{qhB}{2 π m} = mc 2 \qquad ( 30 )$$

Where qhB/2πm is the Zeeman (magnetic resonance) term for energy.
Since h is mc²t, we see:

$$\begin{matrix}{mc}^{2} = \frac{g {mc}^{2} tB}{2 π m} & ( 31 ) \\ \frac{I}{t} = f = \frac{qB}{2 π m} & ( 32 )\end{matrix}$$

Where Eq. 32 represents cyclotron resonance. Now, since no emf is perceived when a body is at rest (v=0) in a steady or unchanging magnetic field, we herein propose that a gravity wave is nevertheless promulgated, because any body at rest (v=0) on Earth is still moving with its celestial frame of reference in constant velocity motion, e.g. Earth's orbital velocity; whereas the force carriers (photons) of a magnetic field move at the velocity of light, independent of their source, and its state of motion. The laws for a body at rest and a body in constant velocity motion, e.g. Earth's orbital velocity, are the same; and a body at rest on Earth (v=0) is moving with constant velocity motion (with the Earth). Newton did not distinguish between terrestrial velocity and celestial velocity, as did Aristotle. Therefore, in mc²=Bvlq, (Jacobson Resonance) the intrinsic energy of a particle, when equal to the wave energy of a body of length (L) interacting with a magnetic field (B), and wherein the body (L) contains the particle (m), a coherent excitation is produced in (m).

If space is filled with an infinite sea of energy; as gravity is everywhere omnipresent, and gravitational field may also be designated as space (5,6), then mc²=BvLq represents inertial electromagnetic induction of resonant coherent vibrational amplifications in (m). This is based in quantum gravitational communication, i.e. a gravity wave (lossless and independent of thermal noise in the environment). It is the case when a body is at rest (v=0) or is in motion, and when said body is immersed in a steady or changing magnetic field.

There must be induction and promulgation of a gravity wave, so long as there is no such thing as absolutely empty space (6).

The force carriers of a magnetic field, i.e. photons, move at the velocity of light, independent of their inertial frame of reference, i.e. the propitiating source of magnetic field production, and transmission of force (pressure wave of deforming or reforming character). (7,8) Quantum mechanical view of the quantum vacuum supports this contention (6) and experimental validation has been based upon the following sample calculation (among numerous others).

### Sample Calculation and Studies

Nerve growth factor (NGF) exhibits trophic influences on a variety of neuronal populations; promoting survivability, regulation of synaptic transmissions, and plasticity at adult synapses in many regions of the central nervous system; and homeostatic regulation of intrinsic neuronal excitability. NGF contains an anti-apoptosis inducing segment to prevent cell death. Choosing NGF as a target, we consider the following:

(1) NGF is 26,500 Dalton, or 4.425×10⁻²⁰ gram

(2) C²=9×10²⁰ cm² sec⁻²

(3) (L) is the height of a human, or 177 cm.

(4) (V) is Earth orbital velocity, or 3×10⁶ cm sec⁻¹

(5) (q) is one ab-coulomb (unit charge by definition)

The CGS system of physical units is chosen, because, in the MKS (SI) system force is determined between moving charges, whereas in the CGS system force is determined between stationary charges. Therefore, we desire:

Mc²=BvLq

(4.425×10⁻²⁰ gm)(9×10²⁰ cm² sec⁻²)=(7.5×10⁻⁸ Gauss)(3×10⁶ cm sec⁻¹)(177 cm)(ab-coulomb) (33)

Then, we note that (q) is normalized in CGS. Consequently, when converting from CGS to MKS, mc²=BvLq becomes mc²=BvL (l0q), because 1 ab-coulomb is equal to 10 coulomb. Therefore, when using the MKS expression, f=qB/2 2πm, we must use f=10 qB/2 2πm, and we note:

$$f = \frac{10 ( 1.6 \times {10}^{- 20} ab \text{-} coul ) 97.5 \times {10}^{- 8} Gauss )}{( 6.2832 ) ( 9.11 \times {10}^{- 28} gm )} = 2.1 Hz \qquad ( 34 )$$

Where, (q) is the charge of an electron and (m) is its mass.

Normalization permits the process of introducing a numerical factor into an equation and is of importance in quantum mechanics.

Pursuant to our thesis, we note the following expressions in CGS derived from mc²=BvLq; defining elements for the unification of matter and space.

$$\frac{\vec{{m}_{0} c} \cdot c}{\sqrt{1 - \frac{{v}^{2}}{{c}^{2}}}} = ( \vec{B} \times \vec{V} ) \cdot \vec{L} ( {q}_{J} )$$

$$\frac{- c}{( \sqrt{1 - \frac{{v}^{2}}{{c}^{2}}} ) {q}_{J} v} \cdot ∮ {mcL}^{- 2} \cdot dL == ( \frac{\partial {A}_{3}}{\partial y} - \frac{\partial {A}_{2}}{\partial z} ) i + ( \frac{\partial {A}_{1}}{\partial z} - \frac{\partial {A}_{3}}{\partial x} ) j + ( \frac{\partial {A}_{2}}{\partial x} - \frac{\partial {A}_{1}}{\partial y} ) k = curIA - ( \vec{∇} \times \vec{A} ) = \vec{∇} \times ∮ \frac{j \vec{\partial S} \vec{\partial L}}{r}$$

Where [symbol] is the magnetic vector potential, and qⱼ is one ab-coulomb (normalized). Relativistic adjustment of mass is annotated, and current is given in ab-amperes, while (ν) represents the inertial velocity, e.g. Earth's orbital velocity. I would urge the young eager minds of this new generation to examine the probability that mc²=BvLq drops out of string theory.

Remember, numerical assignments to unitary measures depend upon the physical model of reference, because the relativity of mass, distance and time is dependent upon the coordinate system of reference chosen consistently. The basic universal field of deepest reality, or purest essence, would no doubt include dark matter and dark energy, of which we currently know virtually nothing, besides their necessary existence.

Indeed, the subtle energies in the pico-Tesla range, measured in association with brain waves and the human heart, by superconducting quantum interference devices or atomic magnetometers, in our opinion, are manifestations of physiologic processes at sub-atomic and atomic levels; pointing to the existence of micro gravitational quantum interactions; undergoing incessant fluctuations required to maintain order in what has been thought to be chaotic models.

Finally, mc²=BvLq, may account for quantum tunneling, the phenomenon necessary for overcoming the quantum barrier, and producing thermonuclear fusion energy.

Black Space Matter (Dark Matter/Dark Energy/Invisible Matter)

Assuming

$$\frac{m}{q t}$$

that yielded

$$\frac{m}{mt}$$

is considered a frequency, i.e., 1.75×10⁷ sec⁻¹, we desire, E=(6.626×10⁻²⁷ erg. Sec)(1.75×10⁷ sec⁻¹=hf=11.955×10⁻²⁰ erg=1.196×10⁻¹⁹ erg

### Then,

E=mc², and we note:

$$\frac{1.196 \times {10}^{- 19} ergs}{9 \times {10}^{30} {cm}^{2} {sec}^{- 2}} = m$$

And,

M=0.133×10⁻³⁹ gm, and

M=1.33×10⁻⁴⁰ gm

The gravitational force is about 10⁴⁰ times weaker than electromagnetic force. This would presume that while photons carry EM force, gravitons carry magnetic force qua magnetic force. This solves an age-old problem.

It is especially interesting to note that Rene Descartes considered our planetary orbit to be a result of Earth's vortical motion to be a result of a ethereal liquid vortex. Thus, the ratio of the mass of a graviton to the mass of a unit electrical charge is 10⁻⁴⁰.

### Sample Calculation

(0.67×10⁻²⁴ gm)C²=mc² (2)

(B)(3×10⁶ cm sec⁻¹)(10 cm)q=BvLq,

When the conductor is only 10 cm for experimental purposes. Then, the derived (B) field is inserted into

$$f = \frac{10 qB}{2 π m}$$

A sample is

$$f = \frac{( 10 ) ( 1.6 \times {10}^{- 20} ab coul ( B )}{2 π ( 9.11 \times {10}^{- 28} gm}$$

As B is derived from mc²=BvLq. In

$$f = \frac{( 10 ) qB}{2 π m} ,$$

m may represent a different charged particle, e.g a quark.

The most efficacious outcome is yielded by (B) fields lower than 10⁻¹⁰ Gauss for small studies. It appears that frequencies are low as 0.0001 Hz. The (B) field is relatively steady for small models. All components that can be made of plastic or other such materials should be made of plastic or other like materials. The environment should be clean from ferrous metals.

Another possibility includes protonic resonance:

### e.g B=⁻¹⁰ Gauss

### Thus,

$$f = \frac{10 ( 1.6 \times {10}^{- 20} ab - C ) ( {10}^{- 11} G )}{6.2832 ( 1.67 \times {10}^{- 24} gm )}$$

$$f \tilde{=} 2.65 \times {10}^{- 6} Hz$$

The foregoing indicates a DC field.
Therefore, amplitude modulation is indicated for nuclear fusion.

We note that it is imperative to establish coherent and congruent oscillatory trajectories for vibrational ionic resultant to cajole deuterium ions to overcome electrostatic repulsion and overcome the quantum barrier. When the ions are close enough to one another gravity will attract the ions and oppositional flow of dark energy will become moot. It must be noted that when 2 coils are utilized, it may be necessary to utilize opposite flows necessary to utilize opposite flows of electrons in the coils to provide Lorentz forces which push the ions together, e.g N→S in one coil and S→N in the other. It is also possible to utilize electron flows in coils that are existent in like directionality to provide relative translational motion of ionic vibrational modes. Similarly, 4 coils or 6 coil systems may utilize analogous methods, i.e. the same or opposite electron flows in the poloidal/solenoidal . . . etc. systems surrounding the vessel containing the ocean water and electrodes.

Of course ionic vector(velocity) is irregular and Lorentz forces may be opposite to that indicated. Thus, it may also be necessary to utilize AC field to induce a pulsating vibrational mode. The foregoing are simply illustrative of possible interactions. AC fields may be extremely low frequency, e.g. less than 1,000 Hz. But, higher frequencies may be utilized. Electric currents in coils are in phase, i.e. the same or opposite polar conditions to provide pulsating ions to provide quantum tunneling.

Two Coil Example: Currents in phase (same polar coordinates) using opposite current orientations also can provide appropriate interactions. Same or opposite polar coordinates may produce overcoming quantum barriers due to random disposition of charges.

However, if the magnetic fields are oriented to provide FQHE (Fractional Quantum Hall Effects) the charges may be piled up and created first to assemble at the edges of the electrode, rendering them more predisposed to affectation; including the production of quesi-particles with fractional electric charges. Thus, directionality of charge orientation is regulable and magnetic field are more calculable.

For small electrode models resonating electrons we note about 3×10⁻¹⁵ Gauss is indicated. For larger models about 10⁻¹⁶ to 10⁻¹⁸ Gauss (B) fields may be indicated. When neutrino masses are targeted for small model electrode systems, about

10⁻¹⁸ Gauss to about 10⁻²⁰ Gauss systems may be indicated. For larger electrode systems, about 10⁻²¹ Gauss (B) fields are indicated for targeting neutrino masses. Below 10⁻²¹, 21 Gauss (B) fields may be utilized for targeting dark energy targetable masses.

For a larger electrode system, L=3.0 cm., using electron resonance we see:

(9.11×10⁻²⁸ gm)(9×10²⁰ cm²sec⁻²)=mc²

Then,

(B)(3×10⁶ cm sec⁻¹)(30 cm(1 ab-c)=BvLq

About 9×10⁻¹⁵ Gauss=B=10⁻¹⁴ Gauss. Neutrino mass at (10⁻⁵, of e⁻)(10⁻¹⁴, 14)˜10⁻¹⁹ Gauss.

Therefore, we assume a flux density range<10⁻²⁰ Gauss.

Dark energy, that is the motion of a particulate components thereof, may be smaller than neutrinos as well. If 10⁻⁴⁹ gm is inserted into me²−BvLq, we get:

(10⁻⁴⁹ gm)(9×10²⁰ cm²sec⁻²)=mc²

BvLq=(B)(3×10⁶ cm²sec⁻²)(30 cm)(1 ab-C)

### Thus,

$$∼ \frac{{10}^{- 28}}{9 \times {10}^{7}} ∼ {10}^{- 36} ,$$

Gauss. The subtle forces of dark energy regulate the quantum barrier (Wall).

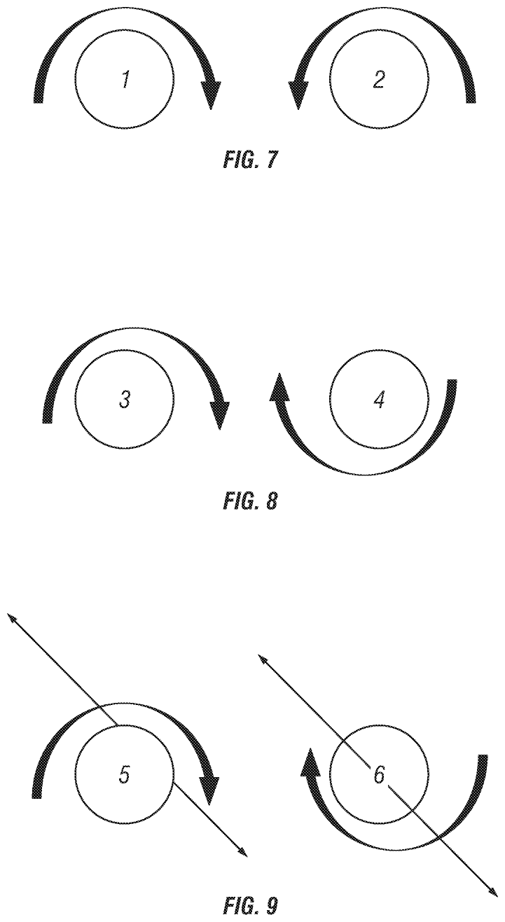

Two particulate masses, 1 and 2, (FIG. 7) reveal opposite spins, opposite rotational dispositions and unlike electric charges, may attract one another due to relative translational motion of black space matter, i.e. dark energy comprising the gravitational field.

Two particulate masses, 3 and 4, (FIG. 8) having the same electric charge, reveal analogous spins/congruent spins, the same rotational dispositions and may repel one another due to opposing relative inertial patterns of black space matter, or dark energy comprising the gravitational field.

We note that particulate masses 5 and 6, (FIG. 9) having like electric charges and oppositional black space matter motion in between said charges may be directed to vibrate in relative translational motion with respect to one another in the same directionality, therein induced to do so secondary to photon/phonon transductions provided by resonant magnetic flux densities imbued within the cathode (A) containing deuterium ions and/or other charged species therein cajoling said particles to approach one another while overcoming the quantum barrier and achieving quantum tunneling; thereby producing thermonuclear and/or thermo-particulate fusion energy to be released as heat and converted into electrical energy.

Regulation of vibrational modes for like charges of particles may induce coherent states such that oppositional forces are reduced. These subtle energies are regulating relativism of particulate interactivity all the time. The fusion system achieves ignition through manipulation of other states of matter via “gravity waves.” The flux density range is 10⁻¹⁰ to 10⁻⁴⁰ Gauss.

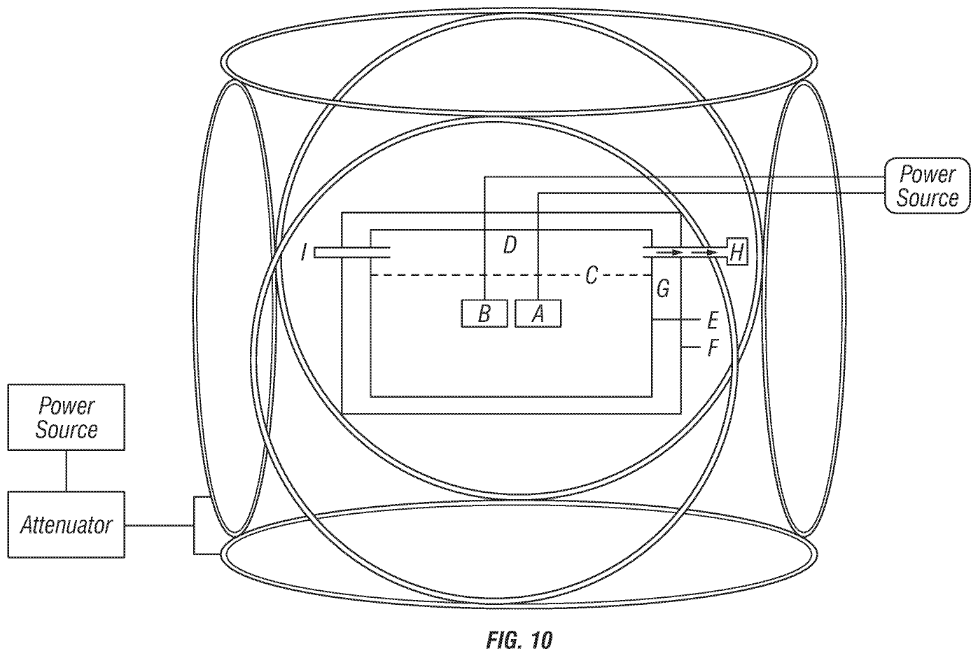

FIG. 10 is a schematic of an example fusion apparatus according to an embodiment of the present disclosure. Utilizing a very simple model including electrodes placed in ocean water and a fenestration above same to permit the flow of heat beyond the system to be converted into electrical energy, we shall fabricate a triple axis coil system to establish an appropriate ambient electromagnetic field.

This field will be calculated using the Jacobson Resonance equation, Mc2=BvLq to establish a photon/phonon transduction wherein the electromagnetic interaction energy produced by the interaction of the ambient EM field and the electrode shall promulgate a gravity wave to return to the phonon field and provide coherent and congruent oscillatory trajectories of deuterium ions such that the ions will be cajoled into moving closer together. This shall be done to overcome the electrostatic repulsion of said ions due to the oppositional flow of dark energy between said ions. The field so calculated will be a close approximation to that necessary to provide the required relative translational motion of said ions, in keeping with outer space magnetic fields as measured by the SQUID in 2006 by NASA ranging from about 10⁻¹¹ gauss to about 10⁻¹⁴ gauss. As I stated earlier, the only explanation for any successful trial in the past has been fortuitous because the ambient EM field was never considered; nor did anyone have a physico-mathematical model to work with in order to ascertain the field necessary to provide resonance.

More specifically, the non-ferrous vessel (E) containing ocean water and/or heavy water (C) will be surrounded by a vacuum (F) and another non-ferrous containment vessel (G) will surround the vacuum (F). Adjustments will be made with fenestrations above the water level on one side (I), to add heavy water as needed, and on the other side, to permit heat leading to a thermocouple (H). The cathode (A) may be palladium or any similar metal of like characteristics, and will be plated and porous to permit deuterons and/or protons to enter the cathode (A). The anode (B) may be made of chromium or other such metals, in as much as chromium is a hard brittle multivalent metal element resistant to corrosion and is an oxidizing agent which may draw oxygen and/or electrons to it within the system of electrolysis. The electrodes will be connected to a power source and based upon the resistance of the circuit elements including mineralized water, a very weak electrical current will be utilized. It is important to note that a system such as this is analogized to the conditions under which a star is born; as opposed to the conditions speculated to exist within the sun wherein inside the photosphere, the temperatures ranges from about 23 million degrees Fahrenheit to about 29 million degree Fahrenheit. Ostensibly, the sun radiates heat and other EM radiant energy to outer space whereas a Tokomak magnetic confinement system blocks such radiation to cool the plasma and prevent ignition.

An example of a reaction that may occur in the sun includes:

₁H¹+₁H¹+₁H¹+₁H¹→₂He⁴++₁e⁰+₊₁e⁰+energy

The result of the chain fusion reaction in the sun is the combination of four hydrogen atoms to form a helium atom. The two positrons that may be formed in such a reaction can combine with electrons present in the cathode to mutually annihilate one another producing a pair of gamma rays. The amount of energy equal to the difference between the combined masses of four hydrogen atoms and one helium atom is about 28.3 Mev or about 4.53×10⁻¹² joules. For each proton used in such a reaction 1.13×10⁻¹² joules of energy will be released. Because one gram of protons has about 6.02×10²³ protons, each gram of protons, with respect to this reaction, will release about 6.8×10¹¹ joules of energy. Converting this into electrical energy, we would see 190,000 kilowatt-hours from the reaction of about a gram of protons. This is enough energy to operate a thousand-watt electrical appliance continuously, day and night, for twenty years. Within the cathode, we would provide a photon/phonon transduction promulgating a negative pressure wave of dark matter, i.e. gravitational wave in the quintessence field, to then return to the phonon field of ordinary matter such that the equal intrinsic energy of a proton and/or a deuteron will be mechanically vibrated. This mechanical vibration from a system of dual resonance will regulate the relative translational motion of said protons and/or deuterons such that said motion will oppose the negative pressure wave between two like-charged particles that provide electrostatic repulsion. Thus, the quantum barrier may be overcome as these oppositional forces then cajole, or coax, the ions to move closer together until such time as the gravitational attraction provides fusion.

It is certainly possible that a variety of interactions may occur within the cathode (A) which will produce positrons, positive or negative mesons acting as fermions and or bosons, as well as quesi-particles of fractional electrical charges such as exists in the fractional quantum Hall Effect. Because the triple-axis system regulates the stability of said ions, the fusion process may lead to ignition. Only with the proper ambient magnetic flux densities can such controlled thermonuclear fusion occur, as it does gradually in outer space under conditions of extremely low temperatures and extremely low-level magnetic fields. Because it is proposed that all matter both ordinary and dark matter are ultimately comprised of fundamental magnetic particles, i.e. Leibnitzian monads/magnetic monopoles/elementary electric charges, in conjunction with Einstein and Leibnitzian theory, we note that the relationship between the external field and other states of reality are controllable with magnetic fields. It is obvious that in order to communicate to an atom which is a very small particle, a very weak, resonant, subtle force need be used. Otherwise, we note, that brute forces will influence large collections of atoms only to increase entropic states which ostensibly occurs in strong magnetic confinement test fusion reactors as well as in laser test reactors. The ultimate proposition is that we may in some manner, regulate the constant velocity motion or inertial states of dark matter as it moves within and in between all ordinary matter. This is called inertial electromagnetic induction, or Jacobson Resonance.

Thus, according to some embodiments, the apparatus herein proposed to contain the fundamental system of controlled thermonuclear fusion will be regulated by externally positioned triple axis poloidal coils to regulate the structure of space-time itself, i.e. spin-2 graviton interactions.

### REFERENCES

1. Jacobson, J I. The Application Of Mc²=BVL Coulomb To Plasma Confinement: Ignition In A Fusion Test Reactor. Indian J. THEORETICAL PHYSICS 37: 1-18, 1989
2. Jacobson, Jerry I: STABILIZING PLASMA IN THERMONUCLEAR FUSION REACTORS USING RESONANT LOW LEVEL ELECTROMAGNETIC FIELDS, U.S. Pat. No. 5,198,181, issued Mar. 30, 1993
3. Jacobson J I. Testing for electrogravitational flux quantum circuitry in biological photon-phonon transduction system yields basis for inertial electromagnetic induction and the new particle-wave equation of Jacobson Resonance. OMICS, Engineering J (IER) 2015: http://dx.doi.org/10.4172/2168-9679.1000265
4. Jacobson J. I. A Quantum Theory of Disease including Cancer and Aging. Int. Mol Med. 2016; 3(1): 524-541

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The magnetic force (B) at 6.674×10⁻⁸ gauss is converted into a gravitational force via a photon-phonon transduction, wherein a gravity wave (negative pressure wave) of dark energy strikes the target mass in the 4-dimensional manifold (external field) to therein induce mechanical vibrations of the atomic crystal lattice structure of protons/deuterons such that the translational/rotational motions of said particles will overcome the quantum barrier (electrostatic repulsion) wherein the strong nuclear force will be discharged such that gluonic interactions will enable H⁺ to merge; which leads to gamma ray production from electron-positron mutual annihilation.

We note that a fundamental magnetic flux density of Homo sapiens is represented by a window ranging from about 6.674×10⁻⁸ gauss to about 7.7×10⁻⁸ gauss, the associated frequencies respectively are about 1.9 Hertz to about 2.156 Hertz.

This window of opportunity may be manifested by a diversity of species. Specific flux densities thus far tested, demonstrating the equivalency of magnetism and gravity include: 6.67×10⁻⁸ Gauss at 1.9 Hertz, 7.5×10⁻⁸ Gauss at 2.1 Hertz, 5 Hertz, and 7.5 Hertz; therein representing Jacobson Resonance Harmonic Music Theory directly related to magnetic resonance harmonics.

$$F = G \frac{{m}_{1} {m}_{2}}{{L}^{2}}$$

$$G = 6.674 \times {10}^{- 11} \frac{{m}^{3}}{kg \cdot {sec}^{2}}$$

$$F = ma = \frac{mL}{{t}^{2}} = \frac{{L}^{3}}{{mt}^{2}} \times \frac{{m}_{1} {m}_{2}}{{L}^{2}}$$

$$B = 667 \times {10}^{- 8} Gauss ∼ G$$

$$\frac{F}{q} = vB = electric field$$

Jacobson Resonance maintains that the electric field is converted to a magnetic field, and a magnetic field is converted to a gravitational field when electromagnetic energy is imbued upon any conductive body everywhere in the universe. Thus, all bodies are comprised of fundamental electrically charged particles moving incessantly to therein create magnetic profiles which are consistent with manifest gravitational interactions.

The critical apparatus to provide resonant magnetic flux densities and frequencies is preferably a triple axis coiled system, wherein a glass vessel, having pores of about 2.7 Angstroms is placed in the midst of the space between the coils. This glass vessel is immersed in water at room temperature, wherein free water molecules will pass through said pores to increase humidity within the flask whereas ionization occurs of said matter. The water utilized in this system will have been resonated with signal sets within the window of opportunity as hereunder discussed for several hours before permitting exposure of said system to magnetic flux densities within said window of opportunity, i.e. 6.674×10⁻⁸ Gauss at 1.9 Hertz, to 7.7×10⁻⁸ Gauss at 2.156 Hertz. The signal sets representing one optimal approach would include 0.067 micro gauss at 1.9 Hertz, 0.075 micro gauss at 2.1, 5, and 7.5 Hertz. Various signal sets may be utilized within the aforementioned window of opportunity, including other calculated flux densities, utilizing the Jacobson Resonance Equation mc²=BvLq; wherein the longest dimension of the conductive body is taken to be the L and the constant velocity motion, or inertial velocity is taken to be Earth Rotational, Earth Orbital, Solar System, Star Cluster System, and/or Galactic Velocity representing harmonics of inertial velocities. Ignition of free protons and or deuterons within the glass central vessel may be continuously propagated by immersion within the magnetic system, in addition to continuous fueling of said system by diffusion of free water molecules; induced therein by magnetic field to be freed from hexagonal water.

The widest range of opportunity may be represented by a magnetic flux density from about a micro gauss to about a femto gauss, depending upon the apparatus utilized and the various possible targets other than protons and deuterons, e.g. electrons, quarks, neutrinos, mesons and gravitons.

We further note that a Helmholtz coil configuration may be utilized, as well as a four coil system (double axis) in which the inter-coil distance is equal to the diameter of each coil, and/or a triple axis six-coiled system wherein the inter-coil distance is equal to the diameter of each of the coils. The apparatus hereunder described must be employed to provide magnetic flux densities from about a micro gauss to about a femto gauss with frequencies calculated from the Jacobson Resonance Cyclotron Theoretical framework, F=qB/2πm, wherein q is a constant of proportionality in the CGS system equal to 1.602×10⁻¹⁹ ab-coulomb; whereas B is the magnetic flux density calculated in Gauss from the unified field equation of Jacobson Resonance, mc²=BvLq, wherein q is normalized as a single ab-coulomb. L represents the dimension of the fusion reactor system, v represents inertial velocities (cosmological velocities), the mc² represents the intrinsic energy of a target mass in the equation of Jacobson Resonance, and in F=qB/2πm, m would represent the mass of an electron, and f is the associated frequency with B.

Thus, the target mass may be any component thereof of the fusion reactor system, e.g. protons, deuterons, quarks, electrons, neutrinos, photons, spin-2 gravitons, Higgs Bosons and the elemental structures of dark energy which represent the constant of gravitation as mass influences mass. Additionally, in the fusion reactor system described herein, the magnetic fields utilized may target hexagonal water, as well as free water molecules.

Even aggregations of said atomic and subatomic particles may be targeted with the Jacobson Resonance physico-mathematical apparatus.

It is necessary to consider the fact that free protons and/or deuterons are required for propagation of the thermonuclear fusion reaction utilizing very weak magnetic fields derived from Jacobson Resonance. There are numerous means of producing free protons and/or deuterons for utilization in the aforementioned process.

Model 1: An electrolysis model may be utilized to provide hydrogen gas at the cathode made of platinum and/or palladium such that said hydrogen gas may be broken up, for example, by the atomic crystal lattice structure of platinum into free protons and electrons. Protons and/or deuterons may thus be absorbed into the interstices of a multi-plated platinum cathodic electrode of rectilinear design, such that micro pores and/or fenestrations permit the liberation of particles and energy into the sea water and/or heavy water supplied as fuel.

Model 2: Considering the hydrogen oxygen fuel cell, we know that when hydrogen gas is introduced into the anode made of platinum, the atomic crystal lattice structure of said material will break apart the hydrogen gas into free protons and electrons.

Model 3: A vessel made of glass may be introduced into a water bath such that water molecules diffuse into the central glass vessel increasing the humidity. When the water and entire system itself is introduced into Jacobson Resonance calculated magnetic fields, e.g. 6.674×10⁻⁸ Gauss at 1.9 Hertz, 7.5×10⁻⁸ Gauss, at respective frequencies 2.1 Hertz, 5 Hertz and 7.5 Hertz. The water may be resonated for one hour at each of the aforementioned signals, and then left overnight in a magnetic field of 7.5×10⁻⁸ Gauss at 2.1 Hertz. The electromagnetic fields will imbue mechanical vibrations, i.e. phonons of water molecules, which will be maintained for an extended period of time; as free water molecules are broken up from hexagonal water, they diffuse through the 2.7 Angstrom pores of the glass and are therein ionized providing a room temperature plasma. Due to the maintenance of the photon/phonon transduction interaction, the protons and/or deuterons, depending upon the kind of water used (distilled water will provide protons, sea water will provide mostly protons and some deuterons, and heavy water will provide mostly deuterons), will fuse and thus will provide ignition of said plasma. The aforementioned is a self-sustaining reaction.

In models number 1 and 2, magnetic flux densities will be utilized in the manner hereunder mentioned, so as to imbue vibrational frequencies such that the motions of particulate masses will be regulated in rotational and translational patterns to overcome the electrostatic repulsion of like charge material, i.e. the quantum barrier. Quantum bridges will thus be formulated by excitation of strong nuclear forces to therein provide gluonic reactions such that like charges will be cajoled to come close enough to merge and/or fuse as the magnetic force becomes the gravitational force. When masses are brought very close together, regardless of the size, gravity will take over and cause mass interactions above and beyond electrostatic repulsions. Thus, utilizing most prominently Newton's gravitational constant as a magnetic flux density, we may show the conversion of the electric force to the magnetic force, to the gravitational force.

It should be pointed out that magnetic fields imbue a vibrational frequency into the water molecules that are lasting, as well as altering the degree of hardness and softness of water. Therefore, when the glass vessel is placed in the water that was treated with picoTesla range magnetic fields, the water diffusing through the pores of the glass is being ionized, i.e. electrons are being stripped from atoms. This provides production of ions, H⁺OH⁻ and H₃O⁺ these ionic forms will participate in an endothermic reaction, i.e. producing energy for protonic merging/fusion. The ionization is producing an endothermic reaction, wherein, the heat does not escape the vessel. The water remains at room temperature, wherein, the temperature inside the glass vessel rises precipitously. When this experiment was first done, the water temperature remained at 77 degrees, while the temperature in the flask went to 124 degree Fahrenheit within two days. At this time, the vessel containing the water was emptied, and the temperature in the flask continued to rise to about 140 degree Fahrenheit, as ignition clearly occurred. Since one of the workers sustained a radiation burn, it could be extrapolated that gamma rays were produced by the sustained fusion reaction. Further investigation is indicated, which would require various magnetic field exposures and study for the determination of how best to control the system.

It can be noted, that with model 3, for production of free protons, the amount of energy per unit charge, i.e. voltage across the flask, increases with exposure to resonated water. For example, a measurement of 50 mV was made before resonation of water surrounding the flask, but after resonation, the measurement was 80 mV. Therefore, the energy per unit charge, or electromotive force produced therein, is increased by exposure to magnetic fields millions of times weaker than the geomagnetic field. This may be based upon the gravitational constant of the universe.

There are two possible approaches to application of magnetic flux densities for resonation of hexagonal water, pure water molecules, protons and/or deuterons. Most notably, it is imperative that the water utilized, whether distilled, sea water and/or heavy water be resonated. This process must be accomplished utilizing several magnetic signal sets (including amplitude and frequency) that rest within the parameters of Newton's Gravitational Constant and/or that which may be calculated with the Jacobson Resonance equation mc²=BvLq; requiring the longest dimension of the vessel containing water. This range includes a micro gauss to a femto gauss.

For example, when considering a small system 6.67×10⁻⁸ Gauss to 7.5×10⁻⁸ Gauss may be utilized in consideration of said formula wherein hexagonal water may serve as the target mass. Various adjustments may be denoted when the single water molecule may be targeted before it diffuses through the glass pores to enter the central vessel in which humidity will rise precipitously up to 99% humidity.

In consideration of model 3, concerning a small flask (central vessel containing air) immersed in resonated water, one might consider the following application of Newtonian Theory in combination with Jacobson Resonance Theory.

The Unified Field Equation:

$$1 \tilde{=} \frac{{c}^{2}}{lim \vert m \vert} \tilde{=} \frac{lim B \to G \vert B \vert}{vL}$$

$${e}^{-} , γ ∼ Hb \to mass \to \frac{1}{{c}^{2}}$$

Note: The absolute value signs surrounding m and B in |m| and |B| are defined in Perspectivism as ax|ⁿ|, not the customary |axⁿ|.

The following eclectic consideration may be universally relevant from an empirical point of view.

$$F = ma = \frac{mL}{{t}^{2}} = qvB = \frac{qLm}{tqt} = \frac{qLm}{{qt}^{2}} = \frac{Lm}{{t}^{2}} = F = G ( \frac{{L}^{3}}{{mt}^{2}} ) ( \frac{{m}_{1} {m}_{2}}{{L}^{2}} ) = \frac{{Lm}^{2}}{{mt}^{2}} = \frac{mL}{{t}^{2}} = F \\ ∴ Conversion of B \to F ( Gravitation ) when q = m and L = t$$

Since all reality is explicable in terms of mass, distance and time and the aforementioned is based on the constant nature of the speed of light.

Even more particularly, we shall endeavor to delineate the specifications for a small model capable of ignition for thermonuclear fusion utilizing resonated distilled water, sea water, and/or heavy water. This model should include a vessel approximately 5 inches in diameter by 9 inches in which a closed flask containing air will be immersed therein. The closed flask will be approximately 2.25 to 2.5 inches in its longest dimension and made of glass having microscopic pores of about 2.7 Angstroms. The water shall be resonated with 4 signal parameters each for one hour including 6.67 pT at 1.9 Hertz, 7.5 pT at successive frequencies at 2.1, 5 Hertz and 7.5 Hertz. Of course, the window of opportunity includes most specifically amplitude and frequencies from about 6.67 pT to about 7.7 pT wherein the frequencies range from about 1.9 Hertz to about 2.156 Hertz as calculated with Jacobson Resonance Theory including mc²=BvLq and F=qB/2πm then the fusion reactor system, including the flask and resonated vessel containing the water shall be immersed in a magnetic flux density of about 7.5 pT at 2.1 Hertz overnight.

Said magnetic flux density will affect hexagonal water clusters to thereby induce free water molecules to pass through the glass pores stripping some of electrons. Even more specifically, the free water molecules entering the flask will be ionized such that free protons and/or deuterons, hydroxyl radicals and hydronium ions as well as free electrons will be therein contained. The particulate masses, ionic in nature, will continue to resonate at vibrational frequencies induced therein such that the electrostatic repulsion, i.e. the quantum barrier may be overcome via regulation of rotational and translational motions of the aforementioned ions. Subsequently, ignition of said plasma will result as protons fuse to produce helium plus positrons and energy. The system inside the flask will rise in temperature over the next few days such that ignition will retain subsequent high temperatures to be utilized for the generation of electrical energy. The fusion of said protons and or deuterons will be propagated through activation of the strong nuclear forces between quarks, thus permitting gluonic interactions to overcome electrostatic repulsion. Even more particularly, in order to construct a large fusion test reactor, the longest dimension of the water containing vessel shall be utilized in the Jacobson Resonance equation mc²=BvLq. As the case arises, the range of flux densities to be utilized in the resonation of water as well as fundamental particles including protons, deuterons, electrons, quarks, neutrinos and mesons, the window of opportunity shall range from a micro gauss down to a femto gauss; noting that the magnetic profile of outer space, as measured by NASA, has been delineated to be 10⁻¹⁰ gauss to about 10⁻¹⁵ gauss. This range of flux density has been measured with the superconducting quantum interference detector in nebulae comprised of hydrogen atoms and dust particles exposed to cosmic ray interactivity.

While initiation of star formation may occur at temperatures of about 10 degrees Kelvin, as hydrogen is fused through electromagnetic/gravitational interactions, space is heated such that a protostar may appear at 10 million degrees Fahrenheit. The expiation of commercially viable, relatively safe, and practical thermonuclear fusion power may be hastened and generated thusly by regulating the magnetic flux density most preferably in three axes, x, y, and z. But, double axes and single axis, while less expedient, may be utilized to manifest the fusion reaction, providing ignition of particulate masses that will be self-sustaining.

1-20. (canceled)

21. An apparatus for generating electrical energy using controlled thermonuclear fusion in a shielded environment, the apparatus comprising:
a vessel including electrodes in electrical communication in addition to an external conductive coil arrangement, wherein the vessel is exposed to magnetic fields that pass through the electrodes within an electrolytic system comprising ocean water and/or heavy water that are the sources for deuterium gas, deuterons, protons, or neutrons, including but not limited to, quarks, mesons, electrons, gravitons, Higgs Bosons, neutrinos, and anti-neutrinos, wherein a current is applied to the electrolytic system;
multiple power sources, one or more going to the external conductive coil arrangement, and another power source going to the electrolytic system, wherein a flux density (B) of the magnetic field passes through the vessel which contains various particulate masses to be fused, including one or more of deuterium atoms, deuterons and protons, wherein a magnetic flux density ranges between about 10⁻⁶ Gauss to about 10⁻²¹ Gauss for resonating deuterons and protons to create a quantum tunnel and/or bridge between said particulate masses through a strong nuclear force carried by gluons to therein overcome the quantum barrier created by electrostatic forces, wherein the deuterons and/or protons fuse, yielding helium and energy, wherein the quantum tunnel and/or bridge must satisfy the equation mc²=BvLq, whereas m is the mass of a particle of the deuterons and/or protons, c is the velocity of light, v is an inertial velocity (constant velocity motion) including the mean orbital velocity of the earth, L is a longest dimension of the electrode and/or the longest dimension of the vessel, and q is 1 ab-coulomb, wherein the intrinsic energy of a target mass will be equal to the magnetic flux density energies provided by the external conductive coil arrangement as well as the electromotive force energy provided by a voltage drop across a cathode, wherein the induction of negative pressure waves from an external field of ordinary matter through a gravitational field to therein provide a phonon of a crystal lattice structure of target masses, which will regulate the flow of dark energy and relative translational motion of particulate masses, including one or more of deuterons and protons, to then produce cajoling of masses to fuse as they overcome electrostatic repulsion.

22. A method for providing free protons and/or deuterons accessible to magnetic field intervention as delineated by the specification hereunder and claim 21, the method comprising the steps of:
immersing a glass flask, having only air inside, in water resonated according to the dictates of said claims at one or more of 6.67 pT at 1.9 Hertz, 7.5 pT at 2.1 Hertz, 5 Hertz, or 7.5 Hertz each signal for one hour;
immersing the entire system in a magnetic field created by the external magnetic coil system exposed to 7.5 pT at 2.1 Hertz overnight which frees water molecules from hexagonal water to therein pass through the pores of the glass becoming ionized and maintaining the imbued vibrational frequencies from the magnetic forces therein exposed; and
as the humidity rises to 99%, providing ignition of the plasma.
